(19) United States
(12) Patent Application Publication
(10) Pub. No.: US 2008/0120554 A1
(43) Pub. Date: May 22, 2008

(54) SYSTEM & METHOD FOR FRAME DATA MANAGEMENT SYSTEM (eFDMS)

(75) Inventors: Zhe XU, Suzhou (CN); Ming-Chun PENG, Suzhou (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: HEJIAN TECHNOLOGY (SUZHOU) CO., LTD., Suzhou (CN)

(21) Appl. No.: 11/560,837

(22) Filed: Nov. 17, 2006

(51) Int. Cl. G06F 3/00; G06F 17/00

(52) U.S. Cl. 715/742; 707/104.1; 707/E17.005

(57) ABSTRACT

A method and system for implementing an electronic frame data management system for semiconductor manufacturing automation including the following steps: data is transferred and stored into a first database, product recipe status of the mask-making data is inspected using a double check UI, the mask-making data via a web page is presented without manual searching, the web page having a desired selection, that is automatically obtained and displayed, is presented, queried results to send out directly is obtained and query capabilities are provided, a product recipe data in an output document format is provided, the data is replicated and stored at the first database to a second database configured at a server, historical record of the user is searched remotely, layer-by-layer accuracy verifications of the input process settings is performed, and only the latest information for the product recipe data is ensured for presentation.

### BACKGROUND OF THE INVENTION

1. Field of the Invention

The present invention generally relates to an electronic frame data management system (eFDMS), and more particularly to a system and method for an eFDMS for semiconductor manufacturing automation.

2. Description of Related Art

For over a half century, integrated circuit (IC) design has gone from the invention of the first solid-state transistor to today's multi-million transistor circuits. Accommodating this remarkable evolution of circuit design is the electronic design automation (EDA) industry. From the driving forces of fierce competition to the adherence to Moore's Law, the EDA industry has provided many technological innovations covering a multitude of disciplines. From the invention of hardware definition languages (HDL), to the extension of the marketable life of the semiconductor exposure systems, the EDA industry has continued to evolve to meet the ever-increasing semiconductor industry demands. Productivity, quality, and efficiency have become the main driving forces behind the various improvements in EDA, and especially in the “design-to-manufacturing” technologies relating to frame data management in semiconductor manufacturing automation.

Referring to FIG. 1, a conventional method for managing photomask recipe data in, for example, GDS file format, includes the following steps: First, in step S100, after a mask is fabricated for the lithography mask-making, all of the data are stored under a text file and in an attachment file format on a web page for a web portal at the workstation without having a saved backup copy. Next, in step S102, a user may manually download a plurality of photomask recipe data in the form of a text file using the web portal, and the downstream user may use the data contained in the above text file by searching and data transfering manually line-by-line. Next, in step S104, a downstream user using the photomask recipe data as a text file during the setting up of a new recipe for the workstation would encounter data entry errors, thereby leading to inaccuracies or discrepancies in the setting up of operating settings for mask-making.

In step S106, after the recipe is established at a workstation, if it is desired to inspect or change the current recipe settings, one may perform manual queries or data entry at a user interface at the workstation, wherein accidental inadvertent input errors may likely occur. Next, in step S108, the manual inputting of recipes into a workstation requires a substantial amount of time, which typically takes about 7 to 8 minutes per recipe, and also lacking reusability for the inputted product recipes. Next, in step S110, Upon an update of the product recipe, all of the historical data for the mask-making (including both new and old) will be stored under a selected product recipe, and a user may occasionally make inadvertent errors such as the inputting of the “old” recipe data, which is an older incorrect replaced-version.

### SUMMARY OF THE INVENTION

A system and method for an electronic frame data management system (eFDMS) for semiconductor manufacturing automation includes the following:
1. After the completion of a photo mask, an eFDMS system is used to transfer and store the data into a first database, such as a MySQL database, for the centralized management of the data, and a double check UI is used for inspecting the product recipe status in the first database to perform product recipe management functions;
2. A dynamic web application technology such as ASP.NET technology is used, wherein the mask-making data is stored under a second database, a Microsoft SQL database, and is provided for use by any downstream unit via a web page for a web portal, wherein the downstream unit does not require to have to search the desired data manually line-by-line. On the other hand, the aforementioned web page containing a desired selection is only required to be selected to allow the information of the desired selection to be displayed. A desired selection is any data that is being selected for inclusion as part of the product recipe.
3. When providing downstream users with query capabilities, the eFDMS system is able to obtain the queried results to send out directly, and an output document format may be directly provided for use at the workstation, thereby reducing manual input errors due to human error.
4. Data is backed up and stored at the first database at each workstation, and the operating historical record of the user may be conveniently searched on the eFDMS system remotely, thereby without requiring to be searched at any individual workstation.
5. An eFDMS system self diagnostic mechanism may perform layer-by-layer accuracy verifications of the input process settings.
6. When using the eFDMS system, only the latest information is presented during each search under the default settings, therefore, potential mix-up would likely be avoided.

The above system and method for the electronic frame data management system (eFDMS) for semiconductor manufacturing automation are capable of reducing operation complexity and cycle time, improving user friendliness, and providing improved data accuracy and product quality.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart illustrating the conventional method for the use and management of a photomask recipe data;

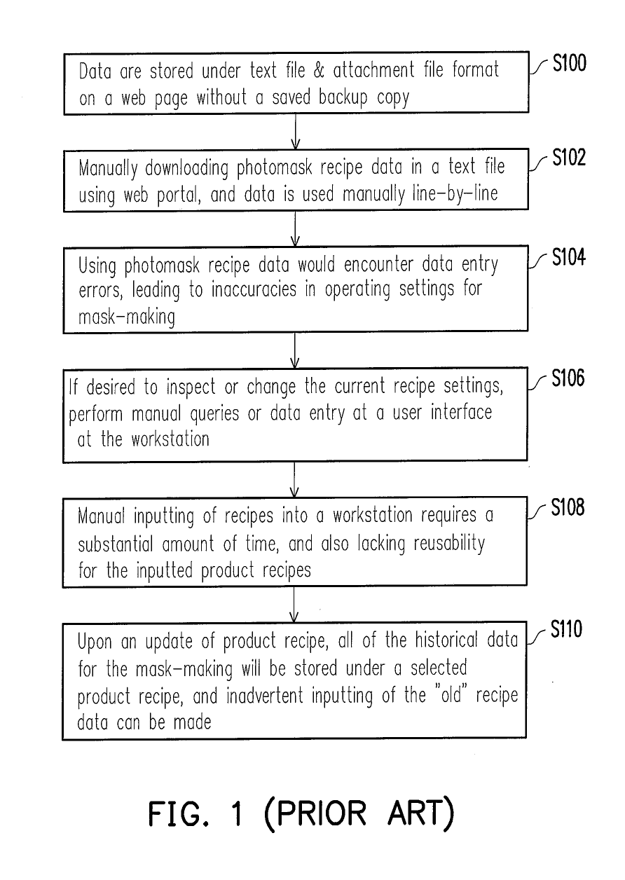

FIG. 2 is a block diagram illustrating an eFDMS for semiconductor manufacturing automation system, according to a first embodiment of the present invention;

FIG. 3 is a flow chart illustrating a method for implementing eFDMS for semiconductor manufacturing automation, according to the first embodiment of the present invention;

FIG. 4 is a flow chart illustrating a method for implementing eFDMS for semiconductor manufacturing automation, according to a second embodiment of the present invention;

FIG. 5 is a general process flow diagram for illustrating the range of operations available at a photo portal, according to a third embodiment of the present invention.

FIG. 6 illustrates a process flow for implementing a WAT portal for the eFDMS for semiconductor manufacturing automation, according to a fourth embodiment of the present invention; and

FIG. 7 illustrates a method for performing layer-by-layer accuracy verifications of the input process settings in the eFDMS, according to the third embodiment of the present invention.

### DETAILED DESCRIPTION OF THE EMBODIMENTS

The present invention will now be described with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

In the drawings, whenever the same element reappears in subsequent drawings, it is denoted by the same reference numeral.

For the sake of convenience of understanding, some key terms are first presented.

A “web portal” is a webpage in a web browser such as Internet Explorer™, Netscape™ Navigator®, Netscape Browser™, Opera™, Mozilla™, Mozilla Firefox™, etc. . . . , an Adobe™ Flash®_page, or an Adobe™ Shockwave® page with a display portion and a user-executable portion.

A “server” is a web server, an application server, a peer-to-peer server a database server, a mobile server, a proxy server, a redirect server, or any other similar types of devices capable of handling the necessary functionalities required by the eFDMS.

A “workstation” is a computer, a lap top, a device with at least a processor, a display, and memory, a desktop, a mainframe, a PDA, a blackberry type device, a server, a web host, or any other similar types of wired or wireless networked device capable of performing the functions required under the eFDMS.

An “application program” is defined as a software program, a java applet, a Java application, an activeX control object, a Javascript object, a Vbscript object, a Microsoft® ASP.NET web service, or any other similar types of software objects capable of providing one or more functionalities.

A “main program” is defined as a software program, a java bean, a Microsoft® ASP.NET web service, or any other fully functional software solutions which are capable of managing, interacting, and supporting a plurality of worskstations and servers for the eFDMS systems.

A “database” is defined as a collection of logically related data designed to meet the information needs of one or more users, and including commercial and noncommercial databases such as Oracle® database, Microsoft® Access™, Microsoft® SQL Server, MySQL® database, PostgreSQL, Ingres®, Firebird® database, Berkeley DB Java Edition, SQLite, IBM® Informix™ database, and other similar systems.

As used herein, the words “may” and “may be” are to be interpreted in an open-ended, non-restrictive manner. At minimum, “may” and “may be” are to be interpreted as definitively including structure or acts recited.

An eFDMS system according to the first through the fifth embodiments of the present invention may be utilized in a semiconductor foundry for integrating the mask making, the photolithography exposure, and the WAT testing processes to form an integrated automated production system in EDA.

The three production processes mentioned above, namely the mask making process, the photolithography exposure process, and the WAT testing process for the foundry in the IC Semiconductor industry typically will use the same system; therefore, the eFDMS system may be used interchangeably.

According to the first through the fifth embodiments of the present invention, the main functions of the eFDMS includes the following:mask making data management,mask making data searching/querying, and mask making data usage.

According to the first through the fifth embodiments of the present invention, the web portal may include any one or more of the following in any conceivable combinations: a photo portal for access by the photolithography department or personnel (during normal use); a WAT portal for access by the WAT department or personnel (during normal use); and a mask house portal for access by the mask shop (all functionalities for the mask shop involves connecting between the internet and the company intranet in which the mask house portal may typically remain in idle status).

According to the first through the fifth embodiments of the present invention, the display screens for displaying the web portal are arranged in a manner that deliver data to the workstation in a form that permits the workstation to generate appropriate instructions for a particular production order. The display screens have various interface features which are familiar to persons who use windows-type operating systems. These features or graphical user interfaces include data entry boxes, pull down menus, selection buttons, and scroll bars.

### First Embodiment

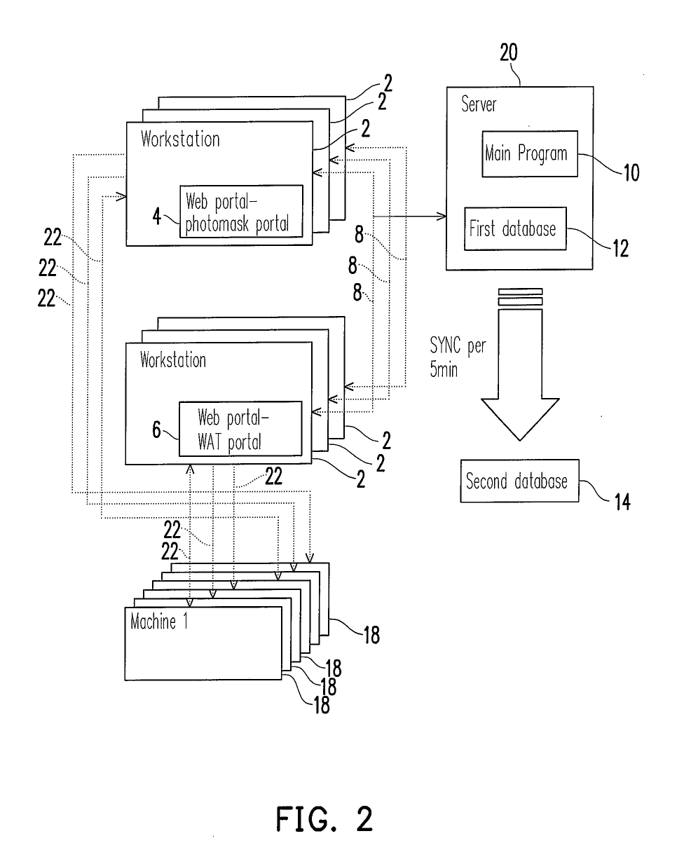

Referring to FIG. 2, an eFDMS for semiconductor manufacturing automation according to a first embodiment of the present invention includes a plurality of workstations 2, a plurality of web portals 4, 6 which are comprised of a plurality of photomask portals 4 and/or a plurality of WAT portals 6, one or more servers 20, a plurality of machines 18, and a main program 10 residing on one or more servers 20.

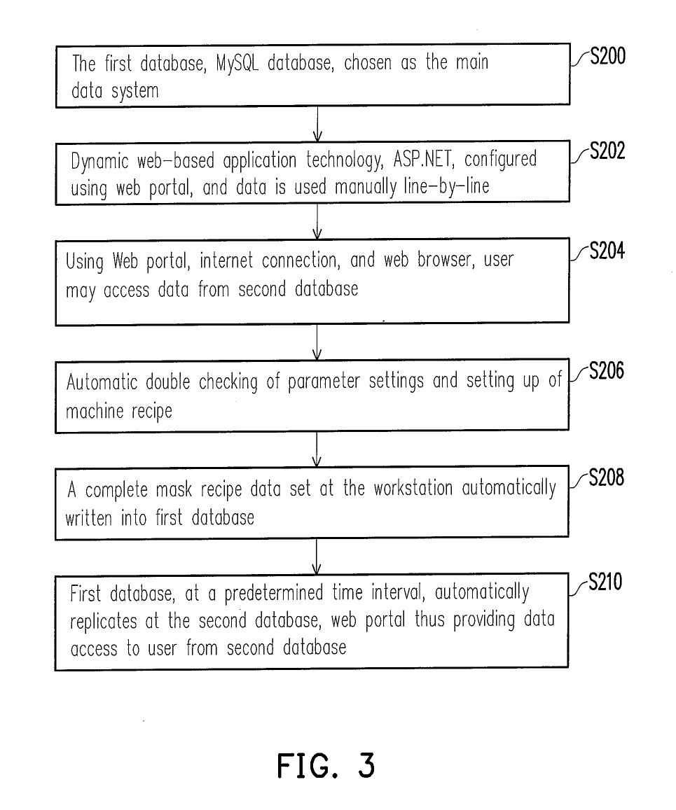

Referring to FIG. 3, a flow chart illustrating a method for implementing the electronic frame data management system (eFDMS) for semiconductor manufacturing automation, according to the first embodiment of the present invention, comprising of the following steps: First, in step S200, the first database, such as a MySQL database, having a high degree of data stability, ease of use, and proper scalability, is chosen as the main data system. Next, in step S202, a dynamic web-based application technology, such as ASP.NET technology, is configured for taking the data from the first database, the MySQL database, to provide access to the user at each of the workstation. Next, in step S204, using a web portal, an internet connection, and a web browser, the user (without having to install any additional software) is able to access the data from the second database, such as a Microsoft SQL database, which has improved usability, workflow efficiency, product quality, and service quality.

In step S206, automatic double checking of parameter settings and setting up of machine recipe are implemented. Next, in step S208, a complete mask recipe data set at the workstation is automatically written into the first database, the MySQL database. Next, in step S210, the first database, the MySQL database, at a predetermined time interval of, for example, 5 minutes, takes its stored data to be automatically replicated at the second database, the Microsoft SQL database, thus allowing a web portal using ASP.NET technology to process the data from the second database, the Microsoft SQL database, via the web portal to provide access to the user.

### Second Embodiment

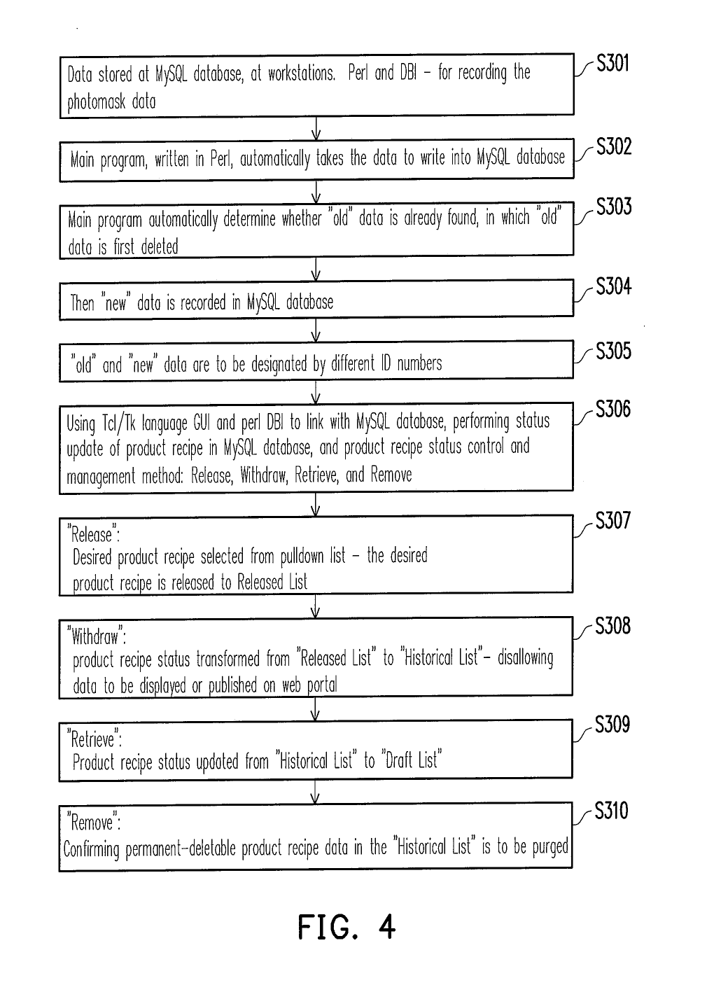

Referring to FIG. 4, a method for implementing eFDMS for photolithography processes for semiconductor manufacturing automation, according to a second embodiment of the present invention includes the following:

1. Data Management

A database interface language such as Perl DBI is used. Perl DBI is a database independent interface for Perl. The Perl DBI and the Perl programming language is a standard API. DBI defines a set of parameters, variables, and uniform database interface, which can fulfill the needs for the eFDMS. Perl is the abbreviation for Practical Extraction and Report Language. Furthermore, programming for the eFDMS may be performed under UNIX environment.

First, in step S301, a plurality of data are stored at a first database, a MySQL database, at a workstation such as a photolithography workstation and a photomask making workstation (using UNIX system). Perl and DBI are utilized for recording the photomask data into the first database, the MySQL database. Next, in step S302, programming is performed under UNIX environment. After the mask is made, a main program, which may be written in per, automatically takes the data to write into the first database, the MySQL database. Next, in step S303, when writing data, the main program may automatically determine whether “old” data is already found in the first database, in which the “old” data in the first database is first deleted. Next, in step S304, then the “new” data is recorded in the first database, and in step S305, the “old” and “new” data for the product recipe in the MySQL database, respectively, are to be designated by different ID numbers for ease of data management.

2. Product Recipe Status Control and Management

In step S306, using Tcl/Tk language GUI in UNIX and connecting with the perl DBI to link with the first database, the MySQL database, for performing status update of a plurality of product recipes in the MySQL database in the workstation, a product recipe status control and management system includes at least four functions, namely Release, Withdraw, Retrieve, and Remove, as shown below:

### “Release” Function:

In step S306, the product recipe data is listed in all of the Draft List in the MySQL database and the desired product recipe is selected from the pulldown list upon selecting “(1) Read From File”; “(2) Select the product” is entered,”; and finally “(3) Release to transform the product to the Released List.” is selected.

### “Withdraw” Function:

In step S308, the product recipe status is transformed from a “Released List” to a “Historical List”, thereby disallowing the data to be displayed or published on the web portal.

### “Retrieve” Function:

In step S309, the product recipe status is updated from the “Historical List” to a “Draft List”.

### “Remove” Function:

In step S310, the confirmed permanent-deletable product recipe data in the “Historical List” is purged from the first database and the second database.

### Third Embodiment

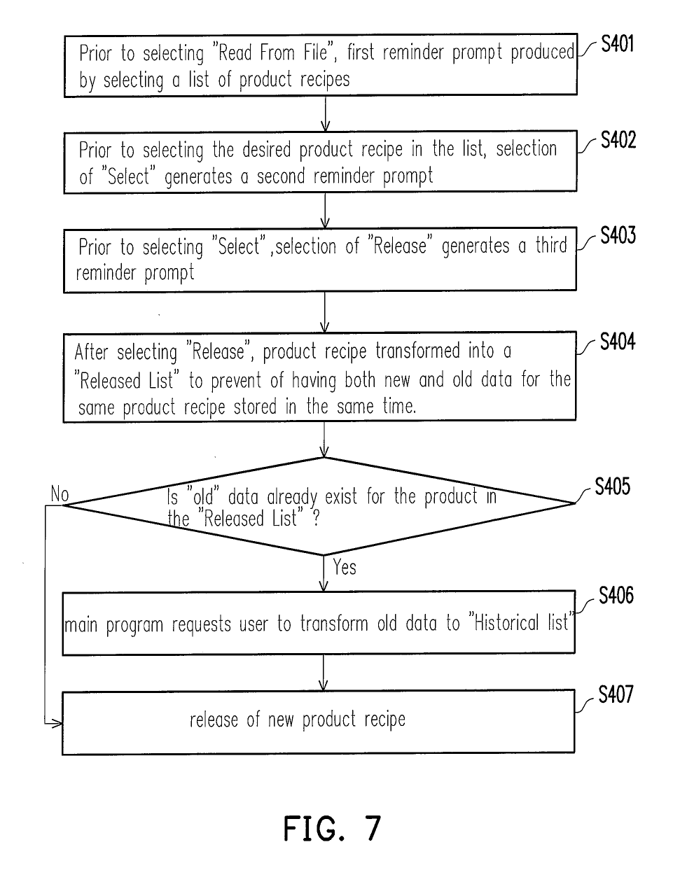

Referring to FIG. 7, a method for performing layer-by-layer accuracy verifications of the input process settings or for error proofing during data entry is included in the main program for implementing the eFDMS, according to a third embodiment of the present invention. The aforementioned method which is applicable for use in a Product Release GUI, a Product Withdraw GUI, a Product Retrieve GUI, and a Product Remove GUI, for ensuring that a correct pre-established order of entry at the web portal are followed, is described as follows: First, in step S401, prior to selecting “Read From File”, a first reminder prompt is produced by selecting a list of saved product recipes. Next, in step S402, prior to selecting the product recipe in the list, the selection of “Select” generates a second reminder prompt. Next, in step S403, prior to selecting the “Select”, the selection of the “Release” generates a third reminder prompt.
1. In step S404, after selecting the “Release”, the product recipe is taken to be transformed into a “Released List” to prevent having both new and old data for the same product recipe stored in the “Released list” at the same time while releasing a product recipe, and in step S405 whether “old” data already exists for the product recipe in the “Released List” is to be determined; and if the answer is found to be YES, in step S406, the main program then requests the user to take the old data to be transformed to a “Historical list”, after which, in step S407 the release of the new product recipe data is permitted. And if the answer is found to be NO, in step S407, the new product recipe data is permitted also without transforming old data to “Historical list”.
2. The above steps 1 to 3 are applicable for use in the Product Release GUI, the Product Withdraw GUI, the Product Retrieve GUI, and the Product Remove GUI.

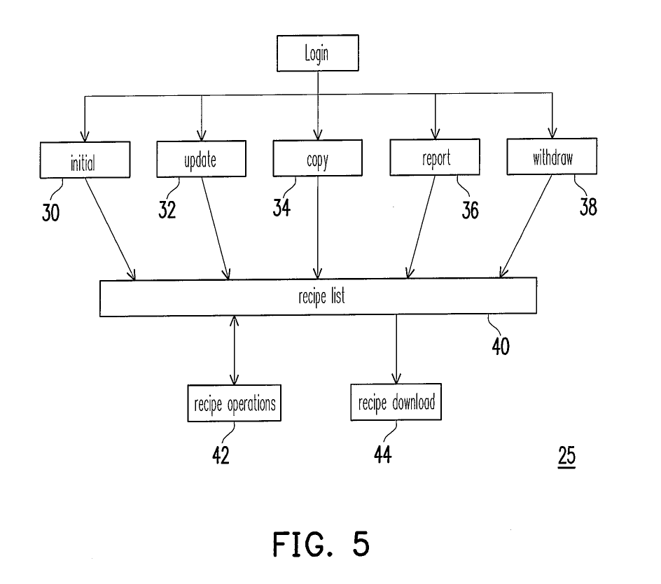

Referring to FIG. 5, a photo portal 25 comprises a range of functions using a plurality of menu buttons, namely an initial button 30, an update button 32, a copy button 34, a report button 36, and a withdraw button 38. The photo portal 25 is further comprising of a recipe list 40, a plurality of recipe operations 42, and a recipe download function 44.

A photo portal 25 may include an item called “PU Type” according to the third embodiment of the present invention. When one of the various different PU Types is selected, such as, for example, KSCAN, ILSTEP, OLSTEP, a product recipe having different formats may be generated and stored in the first database, the user is able to download the desired product recipe in a report page in the web portal to provide to the workstation for use.

### Fourth Embodiment

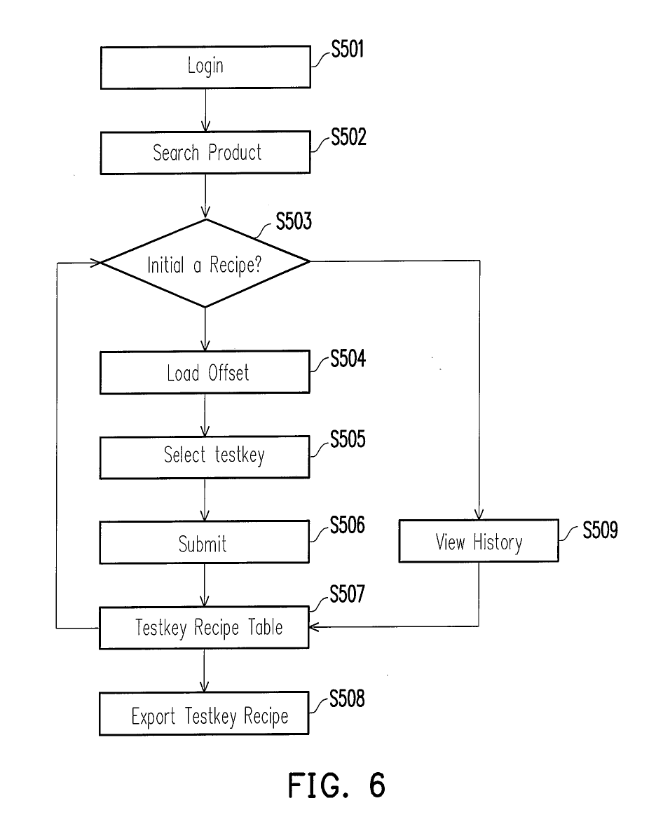

Referring to FIG. 6, a process flow for implementing a WAT portal for the eFDMS for semiconductor manufacturing automation, according to a fourth embodiment of the present invention, comprise of the following steps: First, in step S501, login is commenced. Next, in step S502, searching a desired product recipe. Next, in step S503, initializing a product recipe by pressing the “initial” button. Next, in step S504, loading a map shot offset by pressing the “load” button. Next, in step S505, selecting a plurality of testkeys. Next, in step S506, pressing the “submit” button. Next, in step S507, completing & viewing a testkey recipe table. Next, in step S508, viewing a historical list of textkey history and in step S509, exporting a WAT product recipe in a spreadsheet file format, such as, an EXCEL file format.

### Fifth Embodiment

According to a fifth embodiment of the present invention, approximately 30˜40 layers of photomasks, wherein each layer of photomask is to require one product recipe, are used for a production run for a particular product. As a result, 30˜40 recipes are produced in the fifth embodiment. The eFDMS method as implemented on 30˜40 recipes is able to save between 40% to 60% of the amount of set up time as compared to when using a manual method. According to the fifth embodiment of the present invention, it may only require about 3 hours to set up the 30-40 recipes. In addition, additional shortened cycle time may also be realized by downstream users for not having to double check the recipe settings.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for implementing an electronic frame data management system for semiconductor manufacturing automation, comprising:
transferring and storing of a plurality of data into a first database;
inspecting a product recipe status of a mask-making data in the first database using a double check UI after the completion of a mask;
presenting the mask-making data via a web portal, wherein a user does not require to perform manual searching;
providing a product recipe data in an output document format configured for use at a workstation;
replicating and storing the product recipe data in the first database at each workstation at a second database, wherein the second database in configured at a server;
searching a plurality of historical record of the user remotely; and
ensuring only the latest information for the product recipe data is correctly presented.

2. The method as claimed in claim 1, wherein further comprising:
selecting and presenting a web page of the web portal comprising a desired selection, wherein a desired selection is automatically obtained and displayed;
obtaining a plurality of queried results to the first database and providing a plurality of query capabilities to users; and
performing a plurality of layer-by-layer accuracy verifications of the input process settings.

3. The method as claimed in claim 2, wherein the layer-by-layer accuracy verification of the input process settings, comprising:
providing a first reminder prompt by selecting a list prior to selecting “Read From File”;
generating a second reminder prompt by selecting a select option prior to selecting the desired product recipe in the list;
generating a third reminder prompt by selecting a release option prior to selecting the select option;
transforming the product recipe status to a released list for preventing of having both new data and old data fro the same product recipe stored at the same time when releasing a product recipe; and
determining whether old data is already existed for the product recipe in the released list, wherein if yes, the old data is to be transformed to a historical list for the release of the product recipe.

4. The method as claimed in claim 1, wherein the first database is a MySQL database, and ASP.NET technology is configured for use for data transfer and management functions at each of the workstation.

5. The method as claimed in claim 1, wherein the second database is a Microsoft SQL database.

6. The method as claimed in claim 1, wherein the data at the first database is continuously automatically replicated at 5 minute intervals.

7. The method as claimed in claim 1, wherein the web portal is a photo portal, a WAT portal, or a mask house portal.

8. The method as claimed in claim 1, wherein the web page of the web portal comprising a plurality of graphical user interfaces.

9. The method as claimed in claim 8, wherein the graphical user interface is selected from the group consisting of one or more data entry boxes, pull down menus, selection buttons, and scroll bars.

10. The method as claimed in claim 1, wherein the first database is stored at the workstation using perl and DBI.

11. The method as claimed in claim 10, wherein a plurality of functions for the product recipe status control and management system for the web portal, comprising:
a release, wherein the product recipe data is released to a released list;
a withdraw, wherein the product recipe status is transformed from a released list to a historical list, and thereby disallowing the data to be displayed or published;
a retrieve, wherein the product recipe status is updated from the historical list to a draft list; and
a remove, wherein a confirmed permanent-deletable product recipe in the historical list is purged from the first database and the second database.

12. The method as claimed in claim 1, wherein a main program is configured to perform the following functions:
transferring and storing of a plurality of product recipe data into a first database;
automatically determining whether old data is already present in the first database, wherein the old data, if present, shall be deleted, and the new data shall be recorded in the first database.

13. The method as claimed in claim 12, wherein the old data and the new data for a same product recipe are designated by different ID numbers.

14. A photo portal for the web portal in claim 1, comprising:
an initial button, wherein the initial button is pressed for initializing the product recipe;
an update button, wherein the update button is pressed for updating the product recipe;
a copy button, wherein the copy button is pressed for copying the product recipe;
a report button, wherein the report button is pressed for reporting the product recipe;
a withdraw button, wherein the withdraw button is pressed for withdrawing the product recipe;
a recipe list, wherein the recipe list is for listing the product recipe;
a plurality of recipe operations, wherein the plurality of recipe operations is for operating the product recipe; and
a recipe download function, wherein the recipe download function is for downloading the product recipe.

15. A method for implementing a WAT portal for the eFDMS for semiconductor manufacturing automation, comprising:
commencing login;
searching a desired product recipe;
initializing a recipe;
loading the map shot offset;
selecting a plurality of testkeys;
pressing the submit menu button;
completing and viewing a testkey recipe table;
viewing a historical list of a plurality of textkey history; and
exporting the WAT recipe in a spreadsheet file format.
